(19) United States
(12) Patent Application Publication
(10) Pub. No.: US 2025/0368252 A1
(43) Pub. Date: Dec. 4, 2025

(54) HELICAL GEAR UNIT FOR AN AUXILIARY DRIVE, IN PARTICULAR FOR A STEERING GEAR OF A MOTOR VEHICLE

(71) Applicant: IMS GEAR SE & Co. KGaA, Donaueschingen (DE)

(72) Inventors: Stephan OBERLE, Villingen-Schwenningen (DE); Manuel IRION, Trossingen (DE); Sebastian BIRK, Trossingen (DE); Stefan WILLMANN, Hüfingen (DE); Stefan SCHERER, Friedenweiler (DE)

(21) Appl. No.: 19/185,543

(22) Filed: Apr. 22, 2025

(30) Foreign Application Priority Data
May 29, 2024 (EP) 24178745.6

(51) Int. Cl. B62D 3/04; B23P 15/14

(52) U.S. Cl. CPC B62D 3/04; B23P 15/14

(57) ABSTRACT

The invention relates to a helical gear unit (10) for an auxiliary drive, in particular for a steering gear of a motor vehicle, having the following features:
a worm (100) with helical toothing that is designed as globoid toothing or as globoid-like toothing,
a worm wheel (200) that is in meshing engagement with the worm (100),
the toothing of the worm (100) has teeth (130) in at least one of its two axial edge regions (112, 114) having a lower tooth height (H2) compared to the height (H1) of the other teeth of the worm (100).
   In addition, the invention relates to a worm for such a helical gear unit and to a production method for such a worm.

The invention relates to a helical gear unit for an auxiliary drive, in particular for a steering gear of a motor vehicle, according to the features of the preamble of claim 1, to a worm in such a helical gear and to a method for producing such a worm.

A helical gear unit of a steering system of a motor vehicle is known, e.g., from WO 2019/057377 A 1. The helical gear unit has a worm and a worm wheel. The worm is globoidal or designed as a globoid. The difference between a globoid as a worm and a globoidal worm is seen in the fact that the globoid maintains a constant distance from the worm wheel over its entire longitudinal extent, wherein this does not apply to a globoidal worm in this document. Instead, a globoidal worm has a region along its longitudinal extent that is engaged with the worm wheel and two further regions, in front of and behind the region of engagement, that are not engaged with the worm wheel.

A further helical gear unit for an auxiliary drive in a motor vehicle is described in DE 19630567 A 1. Therein, the helical gear unit is used for adjustment devices in vehicle seats, such as seat length adjustments, seat back adjustments or seat height adjustments. The gear also has a globoidal worm and a worm wheel that meshes with the worm.

Compared to cylindrical worm gears, in which the worm is cylindrical, the region of engagement in a globoid worm or globoidal worm between the worm teeth and the counter-teeth on the worm wheel is increased due to the curved outer surface of the worm. M ore supporting teeth are engaged, so that the module of the toothing can be selected to be smaller while maintaining the same level of safety.

Compared to helical gear units having cylindrical worms and globoid-type helical gears, helical gear units having globoid worms are characterized by higher load transmission and thus longer service life at the same distance (installation space and materials). Due to the special toothing geometry of the globoid worms, a plurality of tooth pairs are always engaged at the same time. Consequently, there is so-called greater overlap, which reduces the tooth root stress and flank pressure on the helical gear at the same torque. On the other hand, with a globoid worm in helical gear units, more torque can be transmitted with the same tooth root stress and flank pressure than with helical gear units having a cylindrical worm.

The aim of the present invention is to further improve the known helical gear unit having a globoid worm or globoid-type worm with respect to installation space and torque, while nevertheless precluding or largely avoiding damage to the counter gear during operation.

This object is achieved using a helical gear unit having the features of claim 1.

The finding according to the invention essentially consists of the fact that the globoid toothing or globoid-like toothing of the worm has teeth in at least one of its two axial edge regions having a lower tooth height compared to the other teeth of the worm.

It should be noted at this point that the use of the terms globoid worm or globoid toothing are understood to refer not only to toothings of the worm that have purely globoid toothing from one end of the worm to the other end of the worm, but also to toothings that are similar to or approximately similar to a globoid or are even globoidal only in sections.

Said lower tooth height according to the invention for the globoid worms means that the edge regions of the globoid worms cannot cause any damage to the teeth on the worm wheel.

Ideally, at least one tooth or a plurality of teeth at the two axial edge regions of the worm are designed with a lower tooth height as compared to the teeth arranged centrally in the worm.

In a further development of the invention, it is provided that the worm has a center region or edge region that has a cylindrical envelope. In the remaining region, however, the teeth are globoid-shaped.

In a further embodiment of the invention, it is provided that the toothing of the worm has a root circle having a first radius RF and a tip circle having a second radius RK. RK is selected to be larger than RF, where an imaginary center of the root circle is closer to a center axis of the worm than an imaginary center of the tip circle. This ensures that the teeth on the outer edge of the worm are designed to be shorter than those in the center of the worm.

In a further development of the invention, it is provided that the toothing of the worm between the root circle and the tip circle is designed to be concave at least in sections. This allows the teeth to nestle better together when the worm and worm edge roll. In addition, this increases the so-called contact pressure, resulting in improved flank load-bearing capacity of the gear pair.

In another embodiment of the invention, the sharp-edged teeth and, in particular the tooth tips of the worm are designed to be rounded. The rounded design flattens pointed teeth, effectively preventing damage to the counter gear during operation of the helical gear unit.

In another embodiment of the invention, the pressure angle of the helical gear unit is approximately between 13° and 17°, preferably between 14° and 16°.

In the helical gear unit according to the invention, the worm consists of metal, in particular free-cutting steel, and the worm wheel preferably consists entirely of plastic or at least partially of plastic.

The worm wheel may have a gear rim width of about 10 mm to 30 mm, preferably 16 mm to 20 mm.

According to the invention, the worm is designed to be symmetrically or asymmetrically.

In a further development of the invention, the ratio of worm tooth thickness to worm wheel tooth thickness is in the range of approximately 20:80 to 50:50.

The subject matter of the present invention also relates to a worm for use in a helical gear unit according to the invention.

A preferred method for producing a worm according to the invention may have the following process steps:
providing a preferably cylindrical worm blank made of metal;
creating a circumferential concave recess having a radius R, the radius center of which is selected so that the teeth in the center of the worm are produced with full height H1 and the teeth at the edge of the worm with capped height H2;
adding globoid-type toothing or globoid toothing having a root circle radius RF that is smaller than the radius R.

Preferably, subsequently rounding at least the teeth arranged in the edge region of the worm in their tip regions.

Although in the preferred production method a circumferential concave recess should be machined into the metal worm blank, the present invention is not limited to this. On the contrary, such a circumferential concave recess is not required if the contour and design of the teeth of the worm according to the invention are created in the worm blank using any removal method (skiving, chasing, whirling, grinding and cutting). It is only necessary to ensure that the teeth in at least one of the edge regions of the globoid worm are lower in height than in the center of the worm. If it turns out during this production process that, for example, machining results in very sharp-edged or pointed teeth forming on the globoid toothing of the worm, it is then preferably provided that the teeth are rounded in their tip regions, at least in the edge region of the globoid toothing, preferably across the entire globoid toothing. In a further development of the invention, the tips of all of the teeth of the worm are being rounded.

In the following figures, the helical gear unit according to the invention, the associated worm and the manufacturing process for said helical gear unit are explained in more detail using exemplary embodiments.

In the figures:

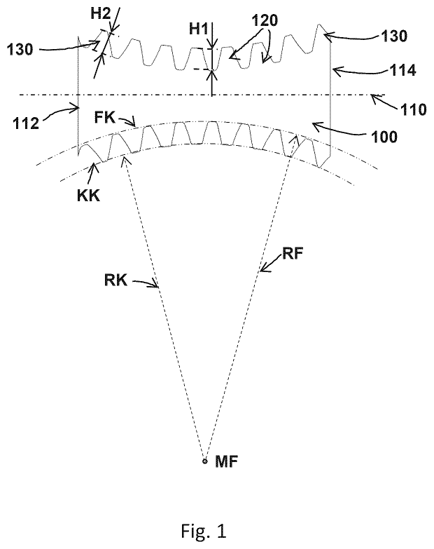

FIG. 1 shows a known globoid worm of a helical gear unit according to the prior art;

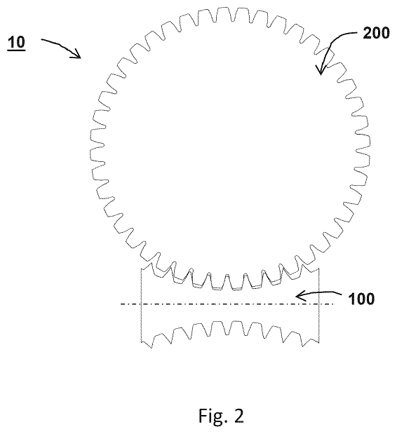

FIG. 2 shows a helical gear unit having a worm wheel and a globoid worm according to the invention;

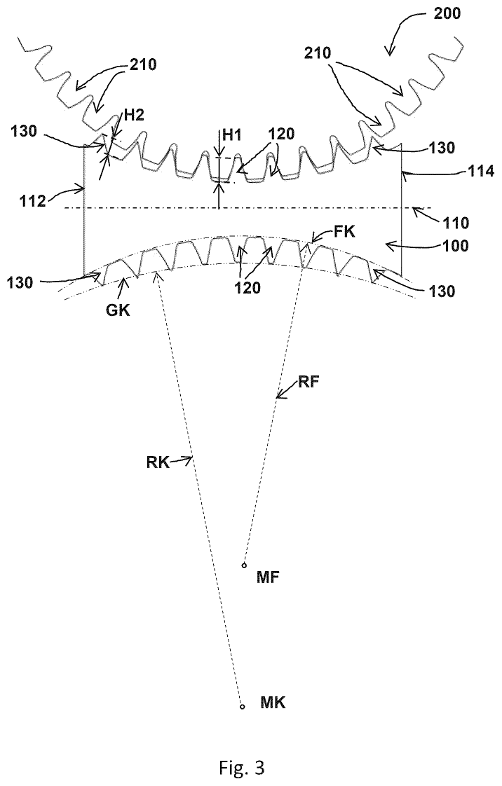

FIG. 3 is a detail representation of the worm of FIG. 1 in the region of engagement with the worm wheel;

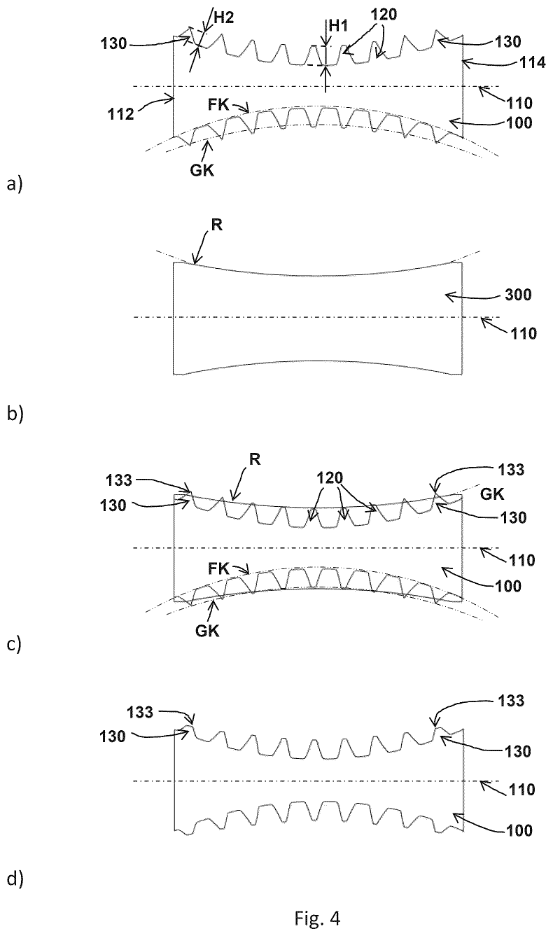

FIG. 4 shows various views of the production process for a globoid worm according to the invention with shortened teeth in the edge region of the globoid worm;

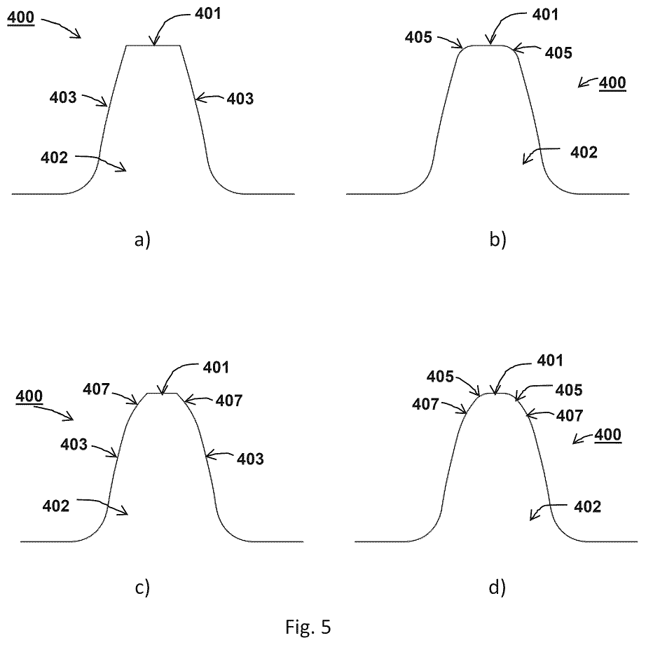

FIG. 5 shows various representations of a tooth profile having tip modifications;

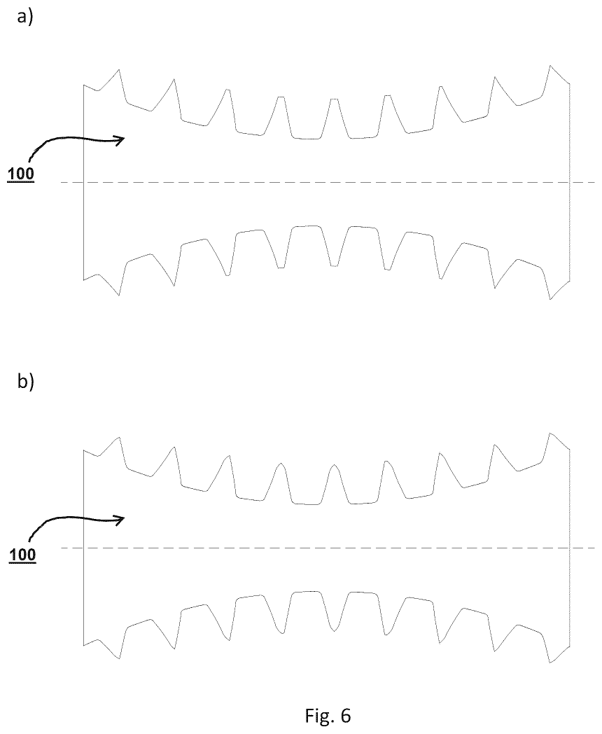

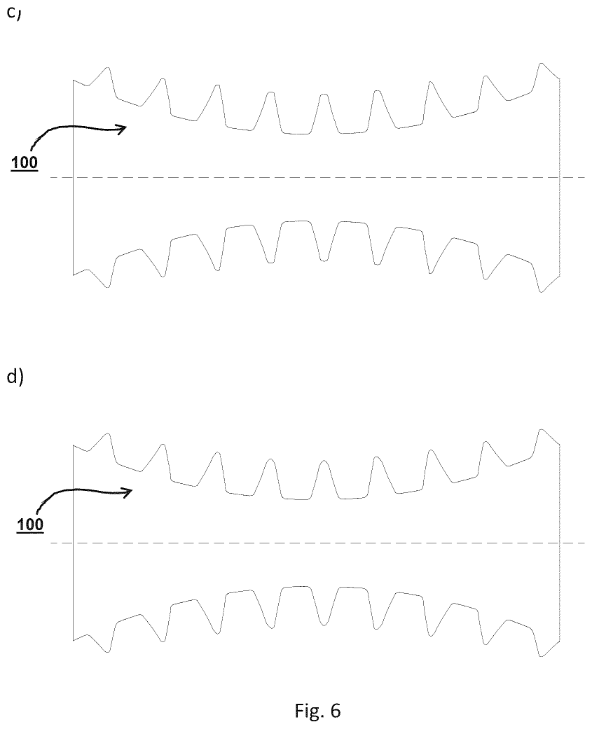

FIG. 6 shows different representations of globoid worms having tip modifications;

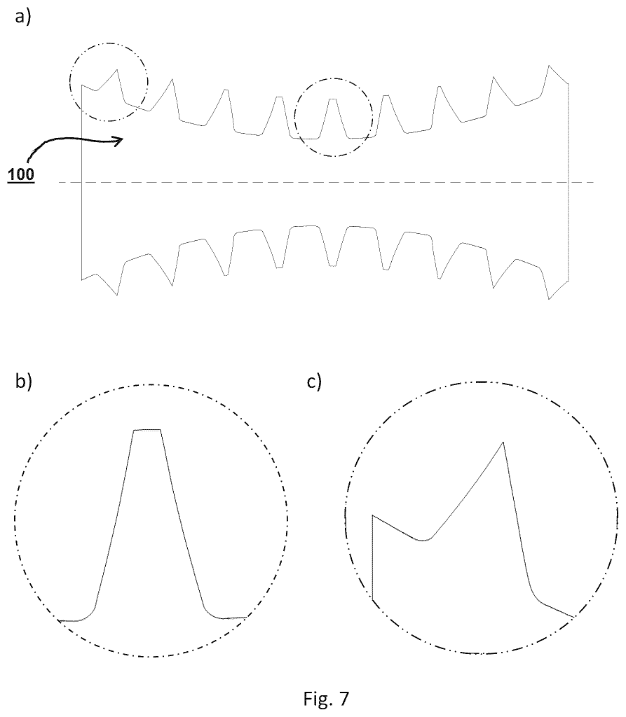

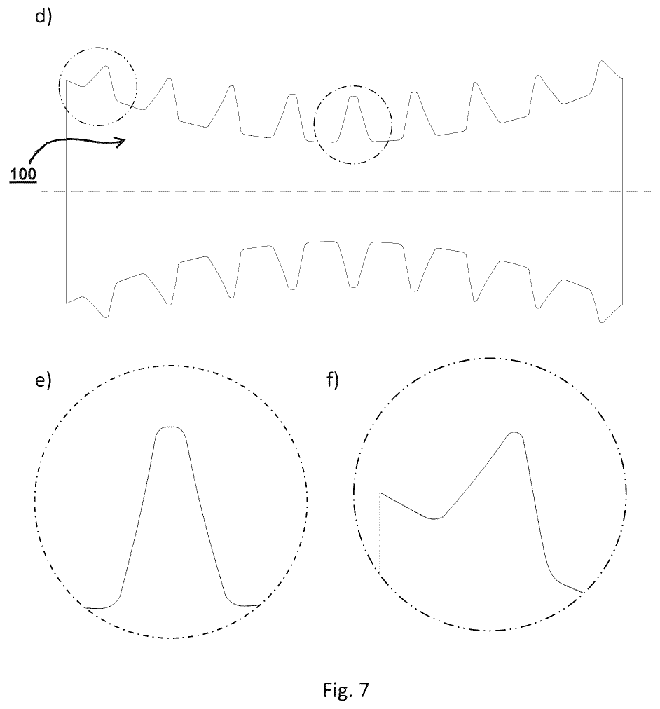

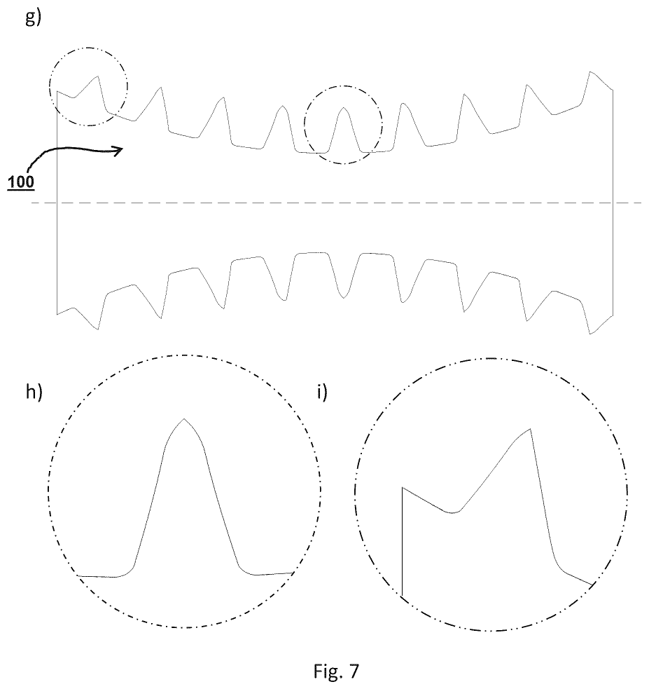

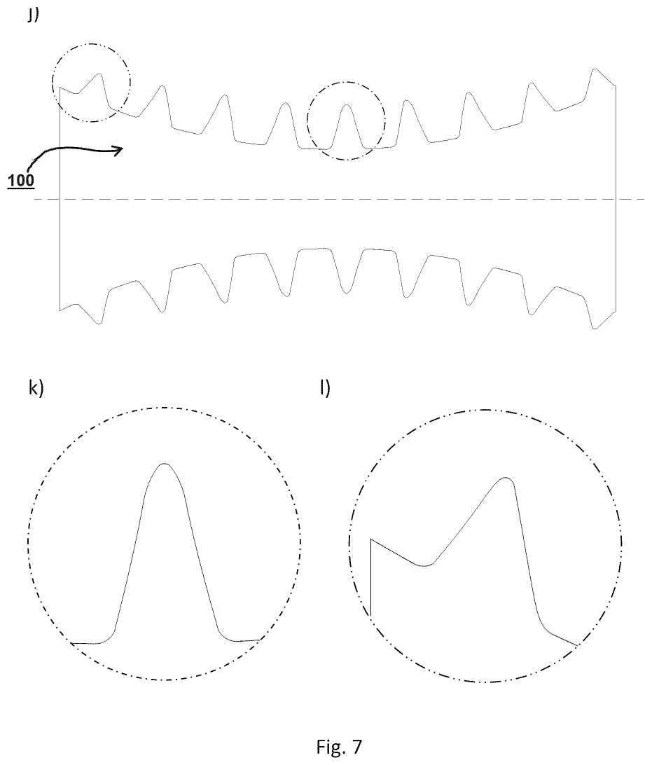

FIG. 7 shows detail representations of modified tooth geometries in the edge region of the globoid worm;

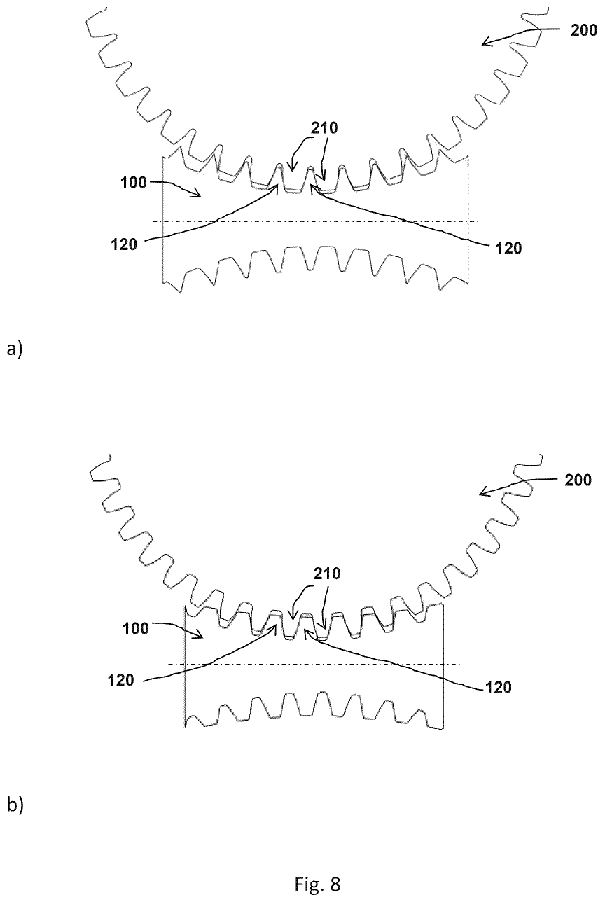

FIG. 8 shows two illustrations of globoid worms in the engagement region with a worm wheel having different tooth thickness ratios;

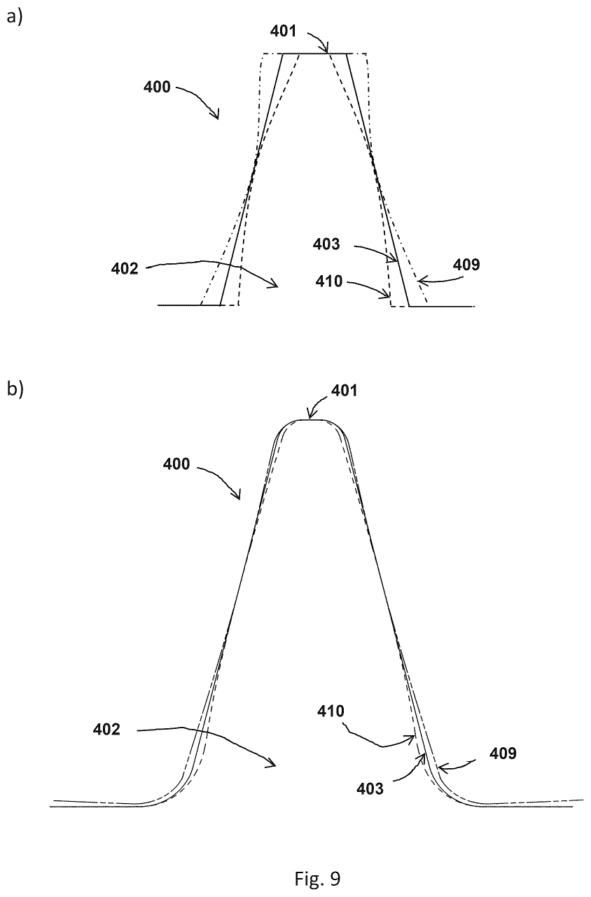

FIG. 9 shows two representations of teeth of a worm having straight, concave and convex flanks; and

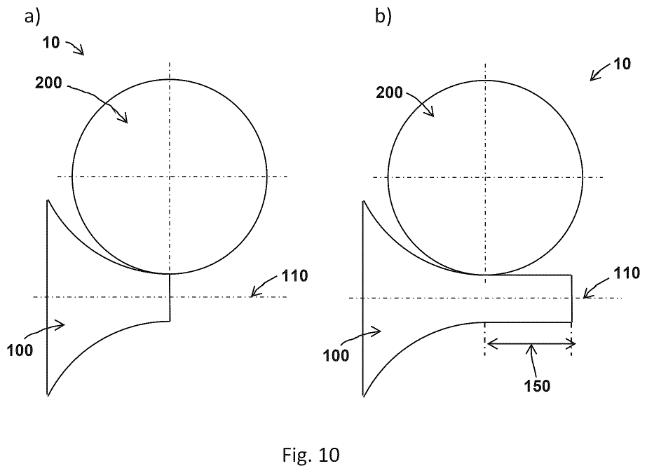

FIG. 10 shows two examples of schematically illustrated helical gear units having an asymmetrical globoid worm.

In the following figures and in the following description, the same reference symbols designate the same parts with the same meaning, unless explicitly stated otherwise.

FIG. 1 shows a previously known worm 100, designed as a globoid worm, as it can be caused to mesh with a helical gear in previously known helical gear units. The worm 100 is symmetrical and has a center axis 110. The worm 100 has a first edge 112 and an opposing second edge 114 to the right in the representation in FIG. 1. The globoid worm 100 has symmetrical globoid toothing arranged about the center axis 110 and having center teeth 120 and outer teeth 130 arranged close to the first edge 112 and the second edge 114, respectively. All teeth 120, 130 of the globoid toothing of said previously known worm 100 have the same tooth height. The center teeth 120 have a height H1 and the outer teeth have a height H2. The heights H1 and H2 result from the distance between the root circle FK of the globoid gear and the tip circle KK. As can be seen from FIG. 1, the root circle FK and the tip circle KK of the globoid toothing of said previously known globoid worm 100 run at the same distance from one another over the entire length of the worm 100, resulting in the identical height of all teeth of the globoid toothing of the globoid worm 100. The root circle FK lies on a radius RF and the tip circle KK on a slightly smaller radius RK, which, however, have a common center point MF.

FIG. 2 shows schematically a helical gear unit 10 according to the invention. Said helical gear unit 10 has a worm 100 made of metal, preferably free-cutting steel, which is designed as a globoid worm having globoidal toothing and meshes with a helical gear 200. According to the invention, the helical gear 200 consists of plastic or at least partially of plastic. The helical gear 200 may also consist of a plurality of components, that is, it may be a so-called multi-component gear. The region of engagement between the globoid worm 100 and the helical gear 200 is the region in which the teeth of the worm 100 mesh with the helical gear 200. In the example shown, the gear ratio is selected to be approximately 80:20. The teeth of the helical gear 200 are therefore about four times as thick as the teeth of the worm.

The toothing of the globoid worm 100 is specially configured in its edge region, specifically it is shorter than in the rest of the region. This becomes clear from the following FIG. 3.

FIG. 3 shows an enlarged representation of the region of engagement of helical gear unit 10 from FIG. 1. The worm 100 has a center axis 110 and a left edge region 112 and a right edge region 114. The worm 100 is provided with globoid toothing on its outer circumference. Said toothing of the worm 100 has teeth 120 in the center region of the worm 100 and teeth 130 arranged close to the left edge region 112 and the right edge region 114. As can be clearly seen from FIG. 2, the teeth 120 in the center region of the worm 100 have a height H1 that is significantly higher than the height H2 of the teeth 130 in the two edge regions 112, 114 of the worm 100. Said lower height H2 as well as a preferred rounding of the teeth 130, which will be explained in more detail in the following description of the figures, ensures that no damage can occur to the sensitive and softer worm wheel 200 made of plastic when the worm 100 meshes with the worm wheel 200.

As can be further seen from FIG. 3, the tooth thickness of teeth 210 of the worm wheel 200 is designed to be significantly greater than that of the teeth 120 and 130 of the worm 100. The ratio of the tooth thickness of the teeth 210 of the worm wheel 200 to the tooth thickness of the teeth 120, 130 of the worm 100 may preferably be in the range between approximately 80:20 and approximately 50:50. Since the load-bearing capacity of plastic gears is significantly lower than that of metal gears, it is advantageous in a plastic-metal pairing to provide the plastic gear, in this case the worm wheel, with a greater tooth thickness, that is, approximately in the range of up to 80:20. Said tooth thickness ratio can be clearly seen in FIG. 3.

Additionally, in FIG. 3 the root circle of the worm gear is designated FK. Said root circle rotates about a center point MF with the radius RF. The tip circle GK of the toothing is designed to be significantly flatter than the root circle FK and has a larger radius RK or larger, approximate radius RK, than RF. In addition, the center MK of the radius RK is far away from the center axis 110 of the worm 100. An imaginary straight line preferably lies between the centers MF and MK orthogonal to the center axis 110 of the worm 100.

In principle, the teeth 130 of the worm 100 located in the edge region 112, 114 can be shortened and preferably also rounded in any manner compared to the teeth 120 in the center of the worm 100. For this purpose, e.g., complete globoid toothing may be provided, which initially provides teeth of equal height both in the edge region 112, 114 and in the center of the worm 100. In a subsequent processing step, the teeth in the two edge regions 112, 114 are then shortened accordingly and preferably also rounded. However, this is a very complex method for producing a worm 100 according to the invention.

FIG. 4a shows a first example of a globoid worm 100 according to the invention. The teeth 120 in the center of the worm 100 have a height H1 and the teeth 130 in the edge region of the globoid worm 100 have a height H2 that is less than the height H1. The radius of the root circle FK and thus its curvature is smaller than the radius, and thus the curvature, of the tip circle GK. The root circle FK and the tip circle GK thus approach the edge regions 112, 114 of the worm.

Such a worm 100 can be produced in any manner. It is only necessary to ensure that the teeth 130 in the edge regions 112, 114 of the worm 100 have a lower height H2 than the teeth 120 in the center of the worm 100. An exemplary method for producing such a worm 100 made of metal consists of first cutting a globoidal tooth contour into a metallic blank, e.g., with a tooth ratio of 50:50. The tooth gaps are therefore approximately the same size as the tooth tips. The toothing is then machined by reducing the tooth thickness so that the tooth tips become significantly narrower and the tooth roots thus become wider. With such a tip reduction of the globoid toothing, the teeth 130 in the edge region 112, 114 of the worm 100 are almost automatically shortened so that they have a reduced height H2 compared to the height H1 of the teeth 120 in the center of the worm 110. With such a reduction in tooth thickness, the teeth 130 in the edge region 112, 114 of the worm 100 become relatively pointed and sharp-edged due to the cutting process. In a subsequent processing step, preferably at least the teeth 130 in the edge region, but preferably also the teeth 120 in the center of the worm 100 and particularly preferably all the teeth of the worm 100, are rounded.

A preferred alternative production method for the worm according to the invention is illustrated in FIGS. 4b to 4d. For producing the worm 100, first a metallic worm blank 300 that is already provided with a radius R on its wall surrounding the center axis 110 is provided. (c.f. FIG. 4b) Said radius R is selected so that in a subsequent step in which the globoid toothing is machined into the blank 300, the teeth 130 located in the edge region 112, 114 cannot have any tips 130 because when the globoid toothing is cut into the blank 300, no material at all is present at this point on the blank 300. This principle is indicated in FIG. 4c.

The cutting of the globoid structure into the blank 300 is carried out such that the teeth 120 in the center of the worm 100 to be produced can be completely formed in their height H1. However, the closer the teeth are arranged to the two edge regions 112, 114 of the worm 100, the more the height H2 of the teeth is reduced due to the radius R selected in the blank 300 because the blank 300 is lacking material there. The tooth region, which is not present at this point, is indicated by the reference number 133 in FIG. 4c, where the tooth region located above the radius R is shown in the drawing, but said tooth region does not actually disappear when cutting the globoid toothing, it is not present there in the first place. The tooth region 133 that is not present is indicated in FIG. 4c for illustration purposes only.

As can be further seen from FIG. 4c, the worm 100 has toothing having a root circle FK that corresponds to the root circle FK of the globoid worm 100 shown in FIG. 4a.

The tip circle of the worm 100 is also identified with the reference symbol GK in FIG. 4c. Said tip circle GK of the globoid worm 100 is identical or almost identical to the radius R of the blank 300. It can clearly be seen that said tip circle GK or R of the globoid worm according to the invention has a larger radius than the tip circle GK of FIG. 4a, that is, of a conventional globoid worm in which the teeth of the worm are all the same height.

FIG. 4d shows the worm 100 with radius R thus produced from the blank in FIG. 4b.

FIG. 5 explains the basics of tooth profiles without tip modification and with tip modification in several sub-figures. FIG. 5a shows a typical tooth profile of a tooth, for example of a worm. The tooth is identified with the reference number 400. The tooth 400 has a tooth tip 401 and a tooth root 402 that are connected to each other via opposing flanks 403. In the illustrated exemplary embodiment of FIG. 5a, the tooth tip 401 has a horizontal course and at each end has an angular transition to the tooth flanks 403.

In FIG. 5b, said tooth 400 is provided with a so-called tip radius at the aforesaid edges. The tip radius is identified on the left and right with the reference number 405. The tip radius 405 leads to a rounding of the aforesaid edges of the tooth 400 in FIG. 5a.

FIG. 5c shows a further tip modification of a tooth 400. Here, material is removed from the edges of the tooth 400 in FIG. 5a, and significantly more material is removed than when producing just a tip radius 405 according to FIG. 5b.

However, as can be seen from FIG. 5c, when the tip is reduced, a small edge still remains on the upper flanks 403 of the tooth 400 to the left and right of the tooth tip 401.

FIG. 5d shows a tooth 400 in which both a tip radius and a tip reduction 407 have been made. It can clearly be seen that the tooth tip 401 is not only rounded, but also significantly thinner than the tooth tips in FIG. 5a and FIG. 5b.

Such a tip modification, in particular of the teeth 130 in the edge region of the globoid worms 100 according to the invention, is shown schematically in connection with FIG. 6.

FIG. 6a shows the tooth profile of a globoid worm 100 without tip modification.

FIG. 6b shows the profile of the toothing of the globoid worm 100 with tip reduction at the teeth in the edge region of the globoid worm 100.

FIG. 6c shows the tooth profile modified with a tip radius and FIG. 6d shows the tooth profile of the globoid worm with tip reduction and tip radius.

Since the profiling of the teeth 130 in the edge region of the globoid worm 100 is difficult to recognize in FIG. 6, the principle of tooth profiling with tip rounding and tip reduction is shown enlarged in FIG. 7.

FIG. 7a shows a globoid worm 100 in which the teeth at the left and right edges of the worm 100 are designed to be shorter than in the center of the worm 100.

FIG. 7b shows, enlarged from FIG. 7a, how a tooth, for example, in the center of the globoid worm 100, is designed.

FIG. 7c shows, in an enlarged view, the tooth at the left edge of the globoid worm 100 in FIG. 7a. The flanks of said tooth are of different lengths and the tooth is asymmetrical. However, it can clearly be seen that said tooth is designed to be pointed, which may lead to the problems mentioned above when meshing with a plastic worm wheel if the tooth is designed to be too long.

FIG. 7d shows the worm 100 in which all teeth have a rounded tip.

FIG. 7e shows a tooth in the center of the globoid worm 100 and having a clearly rounded tip, and FIG. 7f shows a corresponding tooth having a rounded tip in the edge region of the globoid worm 100.

FIG. 7g also shows a globoid worm 100, but here there is a tooth tip reduction, that is, material has clearly been removed in the region of the tooth tip, specifically on the left and right upper flanks of the tooth.

FIG. 7h shows a tooth in the center of the globoid worm 100 and FIG. 7i shows a corresponding tooth of the globoid worm 100 in the edge region of the globoid worm 100.

Finally, FIG. 7j shows a globoid worm 100 with tip rounding and tip reduction. The corresponding tooth in the center of said globoid worm is shown in FIG. 7k and a tooth in the edge region of the globoid worm 100 is shown in FIG. 7l. It can be clearly seen from the contour of the tooth in FIG. 7l that it no longer has a pointed tip, as is desired in the context of the present invention.

FIG. 8a shows the gear pair according to the invention having a tooth thickness ratio of approximately 80:20, i.e. the teeth 210 of the worm wheel 200 are approximately four times as thick as the teeth of the metal worm 100. FIG. 8b shows a similar gear pair, but having a tooth thickness ratio of approximately 50:50 and capped teeth in the edge regions of the worm 100. Both gear pairs are within the scope of the present invention. The teeth located at the edge region of the worm 100 are each significantly less high than the teeth in the center of the worm 100. In addition, said teeth are preferably rounded.

A further variant for the formation and modification of the teeth of the globoid worm 100 is shown schematically in FIG. 9. There, FIG. 9a shows a tooth 400 having tooth flanks 403 and a tip 401 and a tooth root 402. The tooth flanks 403 are straight. The reference numeral 410 indicates a crowned design of the tooth flanks 403 and the reference numeral 409 indicates the course of concave flanks 403. It has proven to be advantageous when realizing the globoid worm 100 according to the present invention to provide a concave or slightly concave shape of the flanks 403 of the teeth, because this contributes to improved flank load-bearing capacity. FIG. 9b shows such an embodiment. While in FIG. 9a the concave or convex design of the tooth flanks 403 is shown greatly exaggerated, FIG. 9b shows approximately the true size ratios for a globoid worm 100 according to the present invention and it can clearly be seen that the concavity is provided essentially in the region of the tooth root or close to the tooth root 402.

While symmetrically designed globoid worms 100 have been described thus far, it is also within the scope of the present invention to use globoid worms in the helical gear unit 10 which are designed asymmetrically and have only a globoid part or section of the toothing.

In FIG. 10a, the globoid worm 100 is embodied as a semi-globoid. This essentially corresponds to a worm 100 as discussed in the previous examples, where the worm 100 is split along half its length of the center axis 110 and only one half of said globoid worm 100 is used in the helical gear unit 10. FIG. 10b also shows such a semi-globoid worm. However, the semi-globoid of the worm 100 is followed by a cylindrical portion 150, i.e., a cylindrical envelope, which may preferably also be provided with toothing. Said cylindrical part is designated by the reference numeral 150 in FIG. 10b.

### LIST OF REFERENCE SYMBOLS

10 Helical gear unit
100 Globoid worm
110 Center axis
112 First edge
114 Second edge
120 Center teeth
130 Outer teeth
133 Missing tooth region
150 Cylindrical region
200 Worm wheel
210 Teeth
300 Worm blank
400 Tooth without tip modification
401 Tooth tip
402 Tooth root
403 Tooth flank
405 Tip radius
407 Tip reduction
409 Concave tooth flank
410 Convex tooth flank
R Radius
H1 First height
H2 Second height
FK Foot circle
GK Tip circle of the globoid worm
RF Root circle radius
RK Tip circle radius
MF Root circle center point
MK Tip circle center point

1. A helical gear unit (10) for an auxiliary drive, in particular for a steering gear of a motor vehicle, having
a worm (100) with helical toothing that is designed as globoid toothing or as globoid-like toothing,
a worm wheel (200) that is in meshing engagement with the worm (100),
characterized in that
the toothing of the worm (100) has, in at least one of its two axial edge regions (112, 114), teeth (130) having a lower tooth height (H2) compared to the height (H1) of the other teeth of the worm (100).

2. The helical gear unit (10) according to claim 1,
characterized in that the worm (200) has at its two axial edge regions (112, 114) one tooth or a plurality of teeth (130) with a lower tooth height (H2) compared to teeth (120) arranged in the center of the worm.

3. The helical gear unit (100) according to claim 1,
characterized in that the worm (200) has a center region or edge region that has a cylindrical envelope or a cylindrical region (150).

4. The helical gear unit (100) according to claim 1,
characterized in that the toothing of the worm (100) has a root circle (FK) having a first radius or at least an approximate radius (RF) and a tip circle (GK) having a second radius (RK), wherein an imaginary center of the root circle (FK) is closer to a center axis (110) of the worm (100) than an imaginary center (MK) of the tip circle (GK).

5. The helical gear unit (10) according to claim 4,
characterized in that the toothing of the worm (100) between root circle (FK) and the tip circle (GK) is designed at least in sections with a concave tooth flank (409).

6. The helical gear unit (10) according to claim 1, characterized in that the tooth tips (401) of the worm (100) are designed to be rounded.

7. The helical gear unit (10) according to claim 1, characterized in that an engagement angle of the helical gear unit (10) is between 13° and 17°, preferably between 14° and 16.

8. The helical gear unit (10) according to claim 1, characterized in that the worm 100 consists of metal, in particular free-cutting steel.

9. The helical gear unit (10) according to claim 1, characterized in that the worm wheel (200) is at least partially, preferably completely, made of plastic.

10. The helical gear unit (10) according to claim 1, characterized in that the worm wheel (10) has a gear rim width of approximately 10 mm to 30 mm, preferably 16 mm to 20 mm.

11. The helical gear unit according to claim 1, characterized in that the worm (100) is designed to be asymmetrical.

12. The helical gear unit (10) according to claim 1, characterized in that the ratio of tooth thickness of the worm (100) to tooth thickness of the worm wheel (200) is in the range of approximately 20:80 to 50:50.

13. A worm (100) for use in a helical gear unit (10) according to claim 1.

14. A method for producing a worm (100) according to claim 13, having the following method steps:
providing a rod-shaped worm blank (300) made of metal;
creating a circumferential concave recess having a radius R, the radius center of which is selected so that the teeth (120) in the center of the worm (100) are produced with full height (H1) and the teeth (130) at the edge of the worm (100) are produced with reduced height (H2);
adding globoid-type toothing to the concave recess having a root circle radius (RF) that is smaller than the radius R; and
rounding at least the tip region (401) of the teeth (130) arranged in the edge region of the worm (100).

15. The method according to claim 14,
characterized in that all teeth (120, 130) of the worm (100) are rounded at their tips (401).
